(19) United States
(12) Patent Application Publication
(10) Pub. No.: US 2025/0361392 A1
(43) Pub. Date: Nov. 27, 2025

(54) POLYMER COMPOSITION COMPRISING POST-CONSUMER RECYCLED POLYMERS

(71) Applicant: INEOS STYROLUTION GROUP GMBH, Frankfurt am Main (DE)

(72) Inventors: Norbert NIESSNER, Friedelsheim (DE); Bianca WILHELMUS, Hanau (DE)

(21) Appl. No.: 18/873,903

(22) PCT Filed: Jun. 12, 2023
(86) PCT No.: PCT/EP2023/065573

§ 371 Date: Dec. 11, 2024

(30) Foreign Application Priority Data
Jun. 13, 2022 (EP) 22178733.6

(51) Int. Cl. C08L 25/12; C08L 27/06; C08L 33/12; C08L 69/00; C08L 75/00

(52) U.S. Cl. CPC C08L 25/12; C08L 27/06; C08L 33/12; C08L 69/00; C08L 75/00; C08L 2207/20

(57) ABSTRACT

The invention relates to a polymer composition P comprising: A: 0.1 to 50 parts by weight of at least one post-consumer recycled polymer as component A; B: 50 to 99.9 parts by weight of at least one post-consumer recycled vinylaromatic copolymer as component B, wherein the post-consumer recycled polymer A is dissolved in the vinylaromatic copolymer B, and/or wherein the post-consumer recycled polymer A is dispersed in form of discontinuous phase domains in a continuous phase of the vinylaromatic copolymer B and wherein the discontinuous phase of the post-consumer recycled polymer A at least comprises phase domains having an average diameter in the range of >30 nm to ≤5 μm.

The present invention relates to a polymer composition P comprising at least one post-consumer recycled polymer and at least one post-consumer recycled vinylaromatic copolymer. It was found that by admixing at least one post-consumer recycled vinylaromatic copolymer, polymer blends of common post-consumer recycled polymers with good compatibility are be obtained. The invention also relates to a process for mechanical recycling of post-consumer polymers, as well as the use of a post-consumer recycled vinylaromatic copolymer for improving the compatibility of recycled polymers.

Mechanical recycling of polymers is the most prominent measure to ensure a circular economy in the polymer sector. With moderate effort for cleaning and compounding, it is possible to substitute virgin polymers, which are typically based on fossil monomers.

Polymer blends are known to have poor mechanical, thermal, and flow properties even when the individual components have very desirable ones. In particular, plastic mixtures have low ductility and poor impact strength, which limits their use to less demanding applications. For high value applications, it is necessary to first separate plastic waste by polymer type. However, high purity of post-consumer recycled polymers, which improves the performance significantly, goes along with higher costs for the separation process (cf. Utracki, Wilkie “Polymer Blends Handbook”, 2nd Ed, Springer Science 2014, Vol. 1, page 126). Processes for the recycling of polymer waste and polymer compositions comprising recycled polymers are generally known in the art. Reference is made for example to JP 2001-279114 A, U.S. Pat. No. 9,631,078, WO 2019/074893, U.S. Pat. No. 7,884,140, US 2014/0228518, EP 3540009, or EP 0543975. As it is hardly possible to obtain post-consumer plastics with 100% purity under economical and technical aspects, a key step for achieving a high quality post-consumer recycled polymer composition is a good miscibility of the to-be-recycled polymer with other polymers.

Miscible or compatible polymer blends are defined in the state-of-the-art as polymer blends, which are homogenous down to the molecular level, i.e. a blend whose domain size is comparable to the dimension of the macromolecular statistical segment (cf. Utracki, Wilkie “Polymer Blends Handbook”, 2nd Ed, Springer Science 2014, Vol. 1, page 20). Thus, the domain size of miscible blends is within the range of just a few nanometers. Compatible polymer blends generally form domains with sizes of <5 nm while incompatible blends form domain sizes>30 nm (cf. Utracki, Wilkie “Polymer Blends Handbook”, 2nd Ed, Springer Science 2014, Vol. 3, page 1859).

It was surprisingly found by the present inventors that polymer blends of post-consumer recycled polymers despite of having domain sizes>30 nm exhibit excellent properties, as long as the polymer blend comprises at least 50 wt.-% of at least one vinylaromatic copolymer.

In particular, the present invention relates to a polymer composition P comprising (or consisting of):
A: 0.1 to 50 parts by weight, preferably 1 to 50 parts by weight, often 10 to 50 parts by weight, of at least one post-consumer recycled polymer as component A;
B: 50 to 99.9 parts by weight, preferably 50 to 99 parts by weight, often 50 to 90 parts by weight, of at least one post-consumer recycled vinylaromatic copolymer as component B, comprising:
   B1: 10 to 100 wt.-% of at least one thermoplastic vinylaromatic copolymer B1, comprising:
      B1.1: 1 to 81 wt.-% of repeating units of styrene and/or styrene derivatives,
      B1.2: 19 to 35 wt.-% of repeating units of acrylonitrile and/or methacrylonitrile, preferably acrylonitrile,
      B1.3: 0 to 80 wt.-% of repeating units of at least one monomer selected from methyl(meth)acrylate (MMA), maleic anhydride (MA), and N-phenyl-maleimide (n-PMI),
      B1.4: 0 to 20 wt.-% of repeating units of at least one further co-monomer different from B1.1, B1.2 and B1.3;
      wherein B1.1, B1.2, B1.3 and B1.4 sum up to 100 wt.-% of the thermoplastic vinylaromatic copolymer B1;
   and
   B2: 0 to 90 wt.-% of at least one impact-modifying polymer B2;
      wherein 1 and B2 sum up to 100 wt.-% of the vinylaromatic copolymer B;
C: 0 to 200 parts by weight, preferably 0 to 150 parts by weight, often 0 to 100 parts by weight, of an essentially non-post-consumer recycled (virgin) vinylaromatic copolymer as component C, comprising:
   C1: 10 to 100 wt.-% of at least one thermoplastic vinylaromatic copolymer C1, comprising:
      C1.1: 1 to 81 wt.-% of repeating units of styrene and/or styrene derivatives,
      C1.2: 19 to 35 wt.-% of repeating units of acrylonitrile and/or methacrylonitrile, preferably acrylonitrile,
      C1.3: 0 to 80 wt.-% of repeating units of at least one monomer selected from methyl(meth)acrylate (MMA), maleic anhydride (MA), and N-phenyl-maleimide (n-PMI),
      C1.4: 0 to 20 wt.-% of repeating units of at least one further co-monomer different from C1.1, C1.2 and C1.3;
      wherein C1.1, C1.2, C1.3 and C1.4 sum up to 100 wt.-% of the thermoplastic vinylaromatic copolymer C1;
   and
   C2: 0 to 90 wt.-% of at least one impact-modifying polymer C2;
   wherein C1 and C2 sum up to 100 wt.-% of the non-post-consumer recycled (virgin) vinylaromatic copolymer C;
and
D: 0 to 10 parts by weight, preferably 0 to 5 parts by weight, often 0 to 3 parts by weight, often 0.1 to 3 pbw., of at least one further additive as component D;
wherein components A, B, C and D sum up to 100 wt.-% of the polymer composition P;
and wherein the post-consumer recycled polymer A is dissolved in the vinylaromatic copolymer B and optionally vinylaromatic copolymer C, and/or
wherein the post-consumer recycled polymer A is dispersed in form of discontinuous phase domains in a continuous phase of the vinylaromatic copolymer B and optionally vinylaromatic copolymer C; and
wherein the discontinuous phase domains of the post-consumer recycled polymer A at least comprise phase domains having an average diameter in the range of from >30 nm to ≤5 μm, preferably >30 nm to ≤2 μm, more preferably >30 nm to ≤200 nm, often >30 nm to ≤100 nm.

According to the present invention, the wording “the post-consumer recycled polymer A is dissolved in the vinylaromatic copolymer B and optionally vinylaromatic copolymer C” means that the post-consumer recycled polymer A and the vinylaromatic copolymer B and optionally vinylaromatic copolymer C form a homogenous mixture at a molecular level. No domains of either of the copolymers A, B, or C are formed within this homogeneous mixture. The homogenous mixture forms a single continuous phase.

It was surprisingly found by the inventors, that by admixing at least one post-consumer recycled vinylaromatic copolymer component B with the post-consumer recycled polymer component A, it is possible to obtain recycled copolymer blends which exhibit good compatibility and sufficient characteristics for further use in different high quality applications.

Without being bound to the theory, it is believed that the vinylaromatic copolymer component B is compatible with a variety of different classes of polymers due to the combination of polar and apolar moieties within the vinylaromatic copolymer B and thus functions as a compatibilizer in the polymer composition P according to the invention. This allows the joint recycling of a variety of polymer components A, which are often not sufficiently compatible, but which are typically present in recycled post-consumer waste.

In terms of the present invention, the term “post-consumer recycled polymer” or “post-consumer recycled vinylaromatic copolymer” refers to a polymer that is prepared from waste plastic material, in particular from recycled durable goods, typically in a recycling and separation process. The post-consumer recycled polymer (i.e. component A) or post-consumer recycled vinylaromatic copolymer (i.e. component B) has passed at least one separate thermal compounding step prior to the admixing step, e.g. an extrusion process, an injection-molding process, etc.

In terms of the present invention “durable goods” or “recycled durable goods” means goods, such as household appliances, machineries, sport equipment, consumer electronics, and automobiles, that are not consumed or destroyed quickly in use, but are expected to last and yield utility a long time, in particular three or more years. In particular, the term “post-consumer products” or “post-consumer durable goods” refers to products or goods after their intended use, in particular after their use for three or more years, e.g. such material is collected and recycled in form of waste plastic material.

In terms of the present invention, the terms “non-post-consumer recycled vinylaromatic copolymer” or “virgin vinylaromatic copolymer” refer to a vinylaromatic copolymer material, which is made from geological resources, and is not made from existing and in particular used material. In terms of the present invention, virgin polymer material means a polymer, which is made from geological resources, such as petroleum, and is not made from existing and in particular used plastic material.

The invention, the constituents A, B, C and D, as well as the polymer composition P are described in further detail herein below.

### Post-Consumer Recycled Polymer A

Post-consumer recycled polymers are typically not single-grade polymers but mixtures comprising varying amounts of different polymer types. Post-consumer recycled polymers which may be used as post-consumer recycled polymers A according to the invention may include polymers selected from the following polymer classes: polyolefins, such as polyethylene (PE), polypropylene (PP) and (ethylene/propylene) copolymers, polyamides (PA), polyesters such as polyethylene terephthalate (PET), polycarbonates (PC), thermoplastic polyurethanes (TPU), polyalkyl(meth)acrylates, such as polymethyl(meth)acrylate (PMMA), polyvinylchlorides (PVC) polystyrene (PS) and vinylaromatic copolymers such as vinylaromatic-diene copolymers (e.g. styrene-butadiene copolymers (SBC)), vinylaromatic-acrylonitrile copolymers (e.g. styrene-acrylonitrile copolymers (SAN) and alpha-methylstyrene-acrylonitrile copolymers (AMSAN)), vinylaromatic-diene-acrylonitrile copolymers (e.g. poly(acrylonitrile-butadiene-styrene) (ABS)) or vinylaromatic-acrylate copolymers (e.g. poly(acrylonitrile-styrene-acrylic ester) (ASA)).

Preferably, the post-consumer recycled polymer A comprises at least one polymer selected from the following polymer classes: polycarbonates (PC), thermoplastic polyurethanes (TPU), polyamides (PA), polyalkyl(meth)acrylates, in particular polymethyl(meth)acrylate (PMMA), polyvinylchlorides (PVC) polystyrene (PS) and vinylaromatic copolymers such as vinylaromatic-diene copolymers (e.g. styrene-butadiene copolymers (SBC)), vinylaromatic-acrylonitrile copolymers (e.g. styrene-acrylonitrile copolymers (SAN) and alpha-methylstyrene-acrylonitrile copolymers (AMSAN)), vinylaromaticdiene-acrylonitrile copolymers (e.g. poly(acrylonitrile-butadiene-styrene) (ABS)) or vinylaromatic-acrylate copolymers (e.g. poly(acrylonitrile-styrene-acrylic ester) (ASA)). Particular preferred non-vinylaromatic copolymers include polycarbonates (PC), polyamides (PA), thermoplastic polyurethanes (TPU), polymethyl(meth)acrylate (PMMA), polyvinylchlorides (PVC). Preferred vinylaromatic copolymers include polystyrene and vinylaromatic-acrylonitrile copolymers such as styrene-acrylonitrile copolymers (SAN), alpha-methylstyrene-acrylonitrile copolymers (AMSAN).

Preferably, the post-consumer recycled polymer A comprises more than 80 wt.-%, more preferably 90 to 100 wt.-%, often 95 to 100 wt.-%, based on the total weigh of the polymer A, of at least one polymer selected from polycarbonates (PC), polyamides (PA), thermoplastic polyurethanes (TPU), polyalkyl(meth)acrylates, in particular polymethyl(meth)acrylate (PMMA), polyvinylchlorides (PVC), polystyrene (PS) and vinylaromatic copolymers such as vinylaromatic-diene copolymers (e.g. styrene-butadiene copolymers (SBC)), vinylaromatic-acrylonitrile copolymers (e.g. styrene-acrylonitrile copolymers (SAN) and alpha-methylstyrene-acrylonitrile copolymers (AMSAN)), vinylaromatic-diene-acrylonitrile copolymers (e.g. poly(acrylonitrile-butadiene-styrene) (ABS)) or vinylaromatic-acrylate copolymers (e.g. poly(acrylonitrile-styrene-acrylic ester) (ASA)).

Preferably, the post-consumer recycled polymer A comprises less than 60 wt.-%, more preferably 0 to 40 wt.-%, often 0 to 20 wt.-%, based on the total weigh of the polymer A, of at least one polymer selected from polyolefins, such as polyethylene (PE), polypropylene (PP) and (ethylene/propylene) copolymers, and polyesters such as polyethylene terephthalate (PET).

In view of the difficulties in separation of polymers during post-consumer recycling, the recycled polymer A often comprises at least two polymers selected from the following polymer classes: polyolefins (such as polyethylene (PE), polypropylene (PP) and (ethylene/propylene) copolymers), polyamides (PA), polyesters such as polyethylene terephthalate (PET), polycarbonates (PC), thermoplastic polyurethanes (TPU), polyalkyl(meth)acrylates, such as polymethyl(meth)acrylate (PMMA), polyvinylchlorides (PVC), polystyrene (PS) and vinylaromatic copolymers such as vinylaromatic-diene copolymers (e.g. styrene-butadiene copolymers (SBC)), vinylaromatic-acrylonitrile copolymers (e.g. styrene-acrylonitrile copolymers (SAN) and alpha-methylstyrene-acrylonitrile copolymers (AMSAN)), vinylaromatic-diene-acrylonitrile copolymers (e.g. poly(acrylonitrile-butadiene-styrene) (ABS)) or vinylaromatic-acrylate copolymers (e.g. poly(acrylonitrile-styrene-acrylic ester) (ASA)).

More preferably, the post-consumer recycled polymer A comprises at least two polymers selected from the following polymer classes polycarbonates (PC), polyamides (PA), thermoplastic polyurethanes (TPU), polyalkyl(meth)acrylates, in particular polymethyl(meth)acrylate (PMMA), polyvinylchlorides (PVC), polystyrene (PS) and vinylaromatic copolymers such as vinylaromatic-diene copolymers (e.g. styrene-butadiene copolymers (SBC)), vinylaromatic-acrylonitrile copolymers (e.g. styrene-acrylonitrile copolymers (SAN) and alpha-methylstyrene-acrylonitrile copolymers (AMSAN)), vinylaromatic-diene-acrylonitrile copolymers (e.g. poly(acrylonitrile-butadiene-styrene) (ABS)) or vinylaromatic-acrylate copolymers (e.g. poly(acrylonitrile-styrene-acrylic ester) (ASA)).

In one embodiment, the recycled polymer A comprises at least one polymer, often at least two polymers, selected from thermoplastic polyurethanes (TPU), polymethyl(meth)acrylates (PMMA), polyamides (PA), polycarbonates (PC), alpha-methylstyrene-acrylonitrile copolymers (AMSAN) and polystyrenes (PS).

The post-consumer recycled polymers A, their preparation and properties are well known in the art and described in the literature. The processes by which the post-consumer recycled polymers A are prepared are not limited.

According to the invention, a polymer class is a group of polymers with common structural features.

The recycled polymers A often comprise additives, which are conventionally used to adjust the properties of the polymers A to improve the processability, the performance characteristics and/or the visual appearance. Examples of such additives include demolding agents, lubricants, flame retardants, colorants, dyes, pigments, fillers, plasticizers, which are generally known in the art and described in the literature (see e.g. “Plastics Additives Handbook”, Hans Zweifel, 6th edition, Hanser Publ., Munich, 2009).

Moreover, since the recycling process is a technical process, which typically is not able to provide recycled polymers of 100% purity, the recycled polymers A often comprise impurities, depending on the previous fields of applications of the polymers, including metal parts, e.g. aluminum, or non-thermoplastic polymers such as polyurethane foams or elastomers.

For the purpose of the invention, all additives account to the total weight of the post-consumer recycled polymer A, i.e. any weight specification for the post-consumer recycled polymer A given herein refers to the post-consumer recycled polymer A as such including the polymer A and all optional additives (and/or optional impurities) present therein.

Post-consumer recycled vinylaromatic copolymer B According to the invention, the polymer composition P comprises 50 to 99.9 parts by weight of at least one post-consumer recycled vinylaromatic copolymer component B, which comprises (or consists of):
B1: 10 to 100 wt.-%, preferably 30 to 100 wt.-%, more preferably 50 to 100 wt.-%, based on the total weight of the vinylaromatic copolymer B, of at least one thermoplastic vinylaromatic copolymer 1, comprising:
   B1.1: 1 to 81 wt.-% of repeating units of styrene and/or styrene derivatives,
   B1.2: 19 to 35 wt.-% of repeating units of acrylonitrile and/or methacrylonitrile, preferably acrylonitrile,
   B1.3: 0 to 80 wt.-% of repeating units of at least one monomer selected from methyl(meth)acrylate (MMA), maleic anhydride (MA), and N-phenyl-maleimide (n-PMI),
   B1.4: 0 to 20 wt.-% of repeating units of at least one further co-monomer different from B1.1, B1.2 and B1.3;
   wherein B1.1, B1.2, B1.3 and B1.4 sum up to 100 wt.-% of the thermoplastic vinylaromatic copolymer B1;
and
B2: 0 to 90 wt.-%, preferably 0 to 70 wt.-%, more preferably 0 to 50 wt.-%, based on the total weight of the vinylaromatic copolymer B, of at least one impact-modifying polymer B2;
wherein 1 and B2 sum up to 100 wt.-% of the vinylaromatic copolymer B.

In one embodiment, the vinylaromatic copolymer B comprises at least one styrene-copolymer and/or an alpha-methylstyrene-copolymer comprising:
B1.1: 65 to 81 wt.-% of repeating units of styrene and/or alpha-methylstyrene, preferably styrene, and
B1.2: 19 to 35 wt.-% of repeating units of acrylonitrile and/or methacrylonitrile, preferably acrylonitrile;
wherein 1.1 and 1.2 sum up to 100 wt.-% of the vinylaromatic copolymer B;

According to one embodiment of the invention, the vinylaromatic copolymer B optionally comprises at least one impact-modifying polymer B2, which is preferably composed of:
B2.1: from 20 to 90 wt.-%, preferably from 40 to 90 wt.-%, more preferably from 45 to 85 wt.-%, often from 50 to 80 wt.-%, based on the total weight of the impact-modifying polymer B2, of a graft base of one or more monomers consisting of:
   B2.11: 70 to 100 wt.-%, preferably 75 to 100 wt.-%, more preferably 80 to 100 wt.-%, based on the total weight of the graft base B2.1, of at least one conjugated diene, in particular butadiene, and/or at least one C₁-C₈ alkyl(meth)acrylate, in particular n-butyl acrylate and/or 2-ethylhexyl acrylate,
   B2.12: 0 to 30 wt.-%, preferably 0 to 25 wt.-%, more preferably 0 to 20 wt.-%, based on the total weight of the graft base B2.1, of at least one further comonomer selected from: styrene, α-methyl styrene, acrylonitrile, methacrylonitrile, methyl methacrylate, maleic acid anhydride and N-phenyl-maleimide, preferably styrene and α-methyl styrene, particularly preferably styrene;
   B2.13: from 0 to 10 wt.-%, preferably from 0.01 to 5, often from 0.02 to 2 wt. %, based on the total weight of the graft base B2.1, of one or more polyfunctional crosslinking monomers, selected from chosen from allyl(meth)acrylate, divinylbenzene, diallylmaleate, diallylfumarate, diallylphthalate, triallylcyanurat, triallylisocyanurat and dicyclopentadienylacrylate (DCPA), which, when component B2.11 is acrylate (e.g. C₁-C₈ alkyl(meth)acrylate), is present in amounts of at least 0.1 wt.-%;
B2.2: from 10 to 80 wt.-%, preferably from 10 to 60 wt.-%, more preferably from 15 to 55 wt.-%, often from 20 to 50 wt.-%, based on the total weight of the impact-modifying polymer B2, of at least one graft layer of one or more monomers consisting of:
   B2.21: from 65 to 95 wt.-%, preferably from 70 to 90 wt.-%, more preferably from 75 to 85 wt.-%, based on the total weight of the graft layer B2.2, of at least one vinylaromatic monomer, preferably styrene and/or α-methyl styrene, in particular styrene;
   B2.22: 5 to 35 wt.-%, preferably 10 to 30 wt.-%, more preferably 15 to 25 wt.-%, based on the total weight of the graft layer B2.2, of acrylonitrile and/or methacrylonitrile, preferably acrylonitrile; and
B2.3: 0 to 30 wt.-%, preferably 0 to 20 wt.-%, more preferably 0 to 15 wt.-%, based on the total weight of the impact-modifying polymer B2, of at least one further constituent selected from:
   at least one monoethylenically unsaturated monomer selected from: methyl methacrylate, maleic acid anhydride and N-phenylmaleimide, preferably methyl methacrylate and/or
   at least one molecular weight regulator, in particular a thiol-based molecular weight regulator such as tert-dodecylmercaptan.

In a preferred embodiment, the impact-modifying polymer B2 is selected from poly(acrylonitrile-butadiene-styrene) (ABS) and poly(acrylonitrile-styrene-acrylic ester) (ASA) and mixtures thereof.

In one embodiment, the impact-modifying polymer B2 according to the invention is an ABS vinylaromatic copolymer composed of:
B2.1: from 40 to 90 wt.-%, based on the total weight of the impact-modifying polymer B2, of a graft base consisting of:
   B2.11: from 70 to 100 wt.-%, preferably from 90 to 99.9 wt.-%, based on the total weight of the graft base (B2.1), of butadiene,
   B2.12: 0 to 30 wt.-%, preferably 1 to 10 wt.-%, based on the total weight of the graft base (B2.1), of styrene and
B2.2: from 10 to 60 wt.-%, based on the total weight of the impact-modifying polymer B2, of a graft comprising:
   B2.21: from 65 to 95 wt.-%, based on the total weight of the graft layer (B2.2), of styrene;
   B2.22: 5 to 35 wt.-%, based on the total weight of the graft layer (B2.2), of acrylonitrile and
B2.3: 0 to 30 wt.-%, based on the total weight of the impact-modifying polymer B2, MMA and/or tert-dodecylmercaptan.

In an alternative embodiment, the impact-modifying polymer B2 according to the invention is an ASA vinylaromatic copolymer composed of:
B2.1: from 40 to 90 wt.-%, based on the total weight of the impact-modifying polymer B2, of a graft base consisting of:
   B2.11: from 70 to 99.9 wt.-%, preferably from 90 to 99.5 wt.-%, based on the total weight of the graft base (B2.1), of at least one C₁-C₈ alkyl(meth)acrylate, preferably n-butylacrylate and/or 2-ethylhexylacrylate, in particular n-butylacrylate,
   B2.12: 0 to 30 wt.-%, preferably 1 to 10 wt.-%, based on the total weight of the graft base (B2.1), of styrene,
   B2.13: 0.5 to 5 wt.-%, preferably 0.1 to 5 wt.-%, in particular 0.5 to 3 wt.-%, most preferred 1 to 2.5 wt.-%, based on the total weight of the graft base (B2.1), of at least one polyfunctional cross-linking monomer, selected from chosen from allyl(meth)acrylate, divinylbenzene, diallylmaleate, diallylfumarate, diallylphthalate, triallylcyanurat, triallylisocyanurat and dicyclopentadienylacrylate (DCPA), preferably selected from allyl(meth)acrylate and DCPA, in particular DCPA, and
B2.2: from 10 to 60 wt.-%, based on the total weight of the impact-modifying polymer B2, of a graft comprising:
   B2.21: from 65 to 95 wt.-%, based on the total weight of the graft layer (B2.2), of styrene;
   B2.22: 5 to 35 wt.-%, based on the total weight of the graft layer (B2.2), of acrylonitrile and
B2.3: 0 to 30 wt.-%, based on the total weight of the impact-modifying polymer B2, of MMA.

In one embodiment of the invention, the post-consumer recycled vinylaromatic copolymer component B comprises 80 to 100 wt.-%, based on the total weight of the vinylaromatic copolymer B, of at least one thermoplastic vinylaromatic copolymer 1. Often, the post-consumer recycled vinylaromatic copolymer component B comprises less than 5 wt.-% of the impact-modifying polymer B2, based on the total weigh of the vinylaromatic copolymer B, often less than 1 wt.-%, for example less than 0.1 wt.-%.

In a preferred embodiment, the post-consumer recycled vinylaromatic copolymer B is selected from the group consisting of styrene-acrylonitrile copolymers, blends of mixtures of at least one styrene-acrylonitrile copolymers with poly(acrylonitrile-butadiene-styrene) (ABS) or poly(acrylonitrile-styrene-acrylic ester) (ASA), and mixtures thereof.

The post-consumer recycled copolymer B often comprises additives, which are conventionally used to adjust the properties of the copolymer B to improve the processability, the performance characteristics and/or the visual appearance. Examples of such additives include demolding agents, lubricants, flame retardants, colorants, dyes, pigments, fillers, plasticizers, which are generally known in the art and described in the literature (see e.g. “Plastics Additives Handbook”, Hans Zweifel, 6th edition, Hanser Publ., Munich, 2009).

For the purpose of the invention, all additives account to the total weight of the post-consumer recycled copolymer B, i.e. any weight specification for the post-consumer recycled copolymer B given herein refers to the post-consumer recycled copolymer B as such including the copolymer B and all optional additives (and/or optional impurities) present therein.

### Non-Post-Consumer Recycled Vinylaromatic Copolymer C

The polymer composition P optionally comprises a further vinylaromatic copolymer C that originates not from post-consumer recycling. The vinylaromatic copolymer C is also designated as virgin vinylaromatic copolymer C and is typically obtained from fossil resources.

According to the invention, the polymer composition P may further comprise 0 to 200 parts by weight of at least one virgin vinylaromatic copolymer component C, which comprises:
C1: 10 to 100 wt.-%, preferably 30 to 100 wt.-%, more preferably 50 to 100 wt.-%, based on the total weight of the vinylaromatic copolymer C, of at least one thermoplastic vinylaromatic copolymer C1, comprising:
   C1.1: 1 to 81 wt.-% of repeating units of styrene and/or styrene derivatives,
   C1.2: 19 to 35 wt.-% of repeating units of acrylonitrile and/or methacrylonitrile, preferably acrylonitrile,
   C1.3: 0 to 80 wt.-% of repeating units of at least one monomer selected from methyl(meth)acrylate (MMA), maleic anhydride (MA), and N-phenyl-maleimide (n-PMI),
   C1.4: 0 to 20 wt.-% of repeating units of at least one further co-monomer different from C1.1, C1.2 and C1.3;
   wherein C1.1, C1.2, C1.3 and C1.4 sum up to 100 wt.-% of the thermoplastic vinylaromatic copolymer C1;
and
C2: 0 to 90 wt.-%, preferably 0 to 70 wt.-%, more preferably 0 to 50 wt.-%, based on the total weight of the vinylaromatic copolymer C, of at least one impact-modifying polymer C2;
wherein C1 and C2 sum up to 100 wt.-% of the vinylaromatic copolymer C.

In one embodiment, the vinylaromatic copolymer C comprises at least one styrene copolymer and/or an alpha-methylstyrene copolymer comprising:
C1.1: 65 to 81 wt.-% of repeating units of styrene and/or alpha-methylstyrene, preferably styrene, and
C1.2: 19 to 35 wt.-% of repeating units of acrylonitrile and/or methacrylonitrile, preferably acrylonitrile, preferably acrylonitrile;
wherein C1.1 and C1.2 sum up to 100 wt.-% of the vinylaromatic copolymer C;

According to one embodiment of the invention, the vinylaromatic copolymer C optionally comprises at least one impact-modifying polymer C2, which is preferably composed of:
C2.1: from 20 to 90 wt.-%, preferably from 40 to 90 wt.-%, more preferably from 45 to 85 wt.-%, often from 50 to 80 wt.-%, based on the total weight of the impact-modifying polymer C2, of a graft base of one or more monomers consisting of:
   C2.11: 70 to 100 wt.-%, preferably 75 to 100 wt.-%, more preferably 80 to 100 wt.-%, based on the total weight of the graft base C2.1, of at least one conjugated diene, in particular butadiene, and/or at least one C₁-C₈ alkyl(meth)acrylate, in particular n-butyl acrylate and/or 2-ethylhexyl acrylate,
   C2.12: 0 to 30 wt.-%, preferably 0 to 25 wt.-%, more preferably 0 to 20 wt.-%, based on the total weight of the graft base C2.1, of at least one further comonomer selected from: styrene, α-methyl styrene, acrylonitrile, methacrylonitrile, methyl methacrylate, maleic acid anhydride and N-phenylmaleimide, preferably styrene and α-methyl styrene, particularly preferably styrene;
   C2.13: from 0 to 10 wt.-%, preferably from 0.01 to 5, often from 0.02 to 2 wt. %, based on the total weight of the graft base C2.1, of one or more polyfunctional crosslinking monomers, selected from chosen from allyl(meth)acrylate, divinylbenzene, diallylmaleate, diallylfumarate, diallylphthalate, triallylcyanurat, triallylisocyanurat and dicyclopentadienylacrylate (DCPA), which, when component C2.11 is acrylate (e.g. C₁-C₈ alkyl(meth)acrylate), is present in amounts of at least 0.1 wt.-%;
C2.2: from 10 to 80 wt.-%, preferably from 10 to 60 wt.-%, more preferably from 15 to 55 wt.-%, often from 20 to 50 wt.-%, based on the total weight of the impact-modifying polymer C2, of at least one graft layer of one or more monomers consisting of:
   C2.21: from 65 to 95 wt.-%, preferably from 70 to 90 wt.-%, more preferably from 75 to 85 wt.-%, based on the total weight of the graft layer C2.2, of at least one vinylaromatic monomer, preferably styrene and/or α-methyl styrene, in particular styrene;
   C2.22: 5 to 35 wt.-%, preferably 10 to 30 wt.-%, more preferably 15 to 25 wt.-%, based on the total weight of the graft layer C2.2, of acrylonitrile and/or methacrylonitrile, preferably acrylonitrile; and
C2.3: 0 to 30 wt.-%, preferably 0 to 20 wt.-%, more preferably 0 to 15 wt.-%, based on the total weight of the impact-modifying polymer C2, of at least one further constituent selected from:
   at least one monoethylenically unsaturated monomer selected from: methyl methacrylate, maleic acid anhydride and N-phenylmaleimide, preferably methyl methacrylate and/or
   at least one molecular weight regulator, in particular a thiol-based molecular weight regulator such as tert-dodecylmercaptan.

In a preferred embodiment, the impact-modifying polymer C2 is selected from poly(acrylonitrile-butadiene-styrene) (ABS) and poly(acrylonitrile-styrene-acrylic ester) (ASA) and mixtures thereof.

In one embodiment, the impact-modifying polymer C2 according to the invention is an ABS vinylaromatic copolymer composed of:
C2.1: from 40 to 90 wt.-%, based on the total weight of the impact-modifying polymer C2, of a graft base consisting of:
   C2.11: from 70 to 100 wt.-%, preferably from 90 to 99.9 wt.-%, based on the total weight of the graft base (C2.1), of butadiene,
   C2.12: 0 to 30 wt.-%, preferably 1 to 10 wt.-%, based on the total weight of the graft base (C2.1), of styrene and
C2.2: from 10 to 60 wt.-%, based on the total weight of the impact-modifying polymer C2, of a graft comprising:
   C2.21: from 65 to 95 wt.-%, based on the total weight of the graft layer (C2.2), of styrene;
   C2.22: 5 to 35 wt.-%, based on the total weight of the graft layer (C2.2), of acrylonitrile and
C2.3: 0 to 30 wt.-%, based on the total weight of the impact-modifying polymer C2, MMA and/or tert-dodecylmercaptan.

In an alternative embodiment, the impact-modifying polymer C2 according to the invention is an ASA vinylaromatic copolymer composed of:
C2.1: from 40 to 90 wt.-%, based on the total weight of the impact-modifying polymer C2, of a graft base consisting of:
   C2.11: from 70 to 99.9 wt.-%, preferably from 90 to 99.5 wt.-%, based on the total weight of the graft base (C2.1), of at least one C₁-C₈ alkyl(meth)acrylate, preferably n-butylacrylate and/or 2-ethylhexylacrylate, in particular n-butylacrylate,
   C2.12: 0 to 30 wt.-%, preferably 1 to 10 wt.-%, based on the total weight of the graft base (C2.1), of styrene,
   C2.13: 0.5 to 5 wt.-%, preferably 0.1 to 5 wt.-%, in particular 0.5 to 3 wt.-%, most preferred 1 to 2.5 wt.-%, based on the total weight of the graft base (C2.1), of at least one polyfunctional cross-linking monomer, selected from chosen from allyl(meth)acrylate, divinylbenzene, diallylmaleate, diallylfumarate, diallylphthalate, triallylcyanurat, triallylisocyanurat and dicyclopentadienylacrylate (DCPA), preferably selected from allyl(meth)acrylate and DCPA, in particular DCPA, and
C2.2: from 10 to 60 wt.-%, based on the total weight of the impact-modifying polymer C2, of a graft comprising:
   C2.21: from 65 to 95 wt.-%, based on the total weight of the graft layer (C2.2), of styrene;
   C2.22: 5 to 35 wt.-%, based on the total weight of the graft layer (C2.2), of acrylonitrile and
C2.3: 0 to 30 wt.-%, based on the total weight of the impact-modifying polymer C2, of MMA.

In one embodiment of the invention, the post-consumer recycled vinylaromatic copolymer component B comprises 80 to 100 wt.-%, based on the total weight of the vinylaromatic copolymer C, of at least one thermoplastic vinylaromatic copolymer C1. Often, the post-consumer recycled vinylaromatic copolymer C comprises less than 5 wt.-% of the impact-modifying polymer C2, based on the total weigh of the vinylaromatic copolymer C, often less than 1 wt.-%, for example less than 0.1 wt.-%.

The non-post-consumer recycled (virgin) vinylaromatic copolymer C often comprises additives, which are conventionally used to adjust the properties of the vinylaromatic copolymer C to improve the processability, the performance characteristics and/or the visual appearance. Examples of such additives include demolding agents, lubricants, flame retardants, colorants, dyes, pigments, fillers, plasticizers, which are generally known in the art and described in the literature (see e.g. “Plastics Additives Handbook”, Hans Zweifel, 6th edition, Hanser Publ., Munich, 2009).

For the purpose of the invention, all additives account to the total weight of the non-post-consumer recycled (virgin) vinylaromatic copolymer C, i.e. any weight specification for the post-consumer recycled polymer A given herein refers to the non-post-consumer recycled (virgin) vinylaromatic copolymer C as such including the vinylaromatic copolymer C and all optional additives (and/or optional impurities) present therein.

Methods for producing the non-post-consumer recycled (virgin) vinylaromatic copolymer C are generally known in the art, and are, for example described by Maul et al. in “Polystyrene and Styrene Copolymers” in Ullmann's Encyclopedia of Industrial Chemistry. Wiley-VCH Verlag GmbH & Co. KGaA, 2005.

### Additive Component D

The polymer composition P may optionally comprise up to 10 parts by weight of at least one further component D.

Suitable additives D include all substances customarily employed for processing or finishing the polymers (see e.g. “Plastics Additives Handbook”, Hans Zweifel, 6th edition, Hanser Publ., Munich, 2009).

Preferred additives D include stabilizers (e.g. UV-stabilizers), oxidation retarders, antioxidants, agents to counter thermal decomposition and decomposition due to light, lubricants and dyes.

These additives D may be admixed at any stage of the manufacturing operation, but preferably at an early stage in order to profit early on from the stabilizing effects (or other specific effects) of the added substance.

Suitable antioxidants are, e.g., one or more compounds selected from mono-phosphite-based antioxidants, di-phosphite-based antioxidants and sterically hindered phenolic antioxidants. If one or more antioxidants are present, they are preferably selected from mono-phosphite-based antioxidants, such as tri-substituted mono-phosphite derivatives, di-phosphite-based antioxidants, such as substituted pentaerythritol di-phosphite derivatives and sterically hindered phenolic antioxidants, such as 2,6-di-tertbutylphenolic derivatives.

Suitable lubricants/glidants and demolding agents include stearic acids, stearyl alcohol, stearic esters, amide waxes (bis-stearylamide, in particular ethylene bis-stearamide), polyolefin waxes and/or generally higher fatty acids, derivatives thereof and corresponding fatty acid mixtures comprising 12 to 30 carbon atoms.

Suitable dyes are any of the dyes which can be used for transparent, semitransparent, or non-transparent coloring of polymers, in particular those dyes which are suitable for coloring styrene copolymers. Dyes of this type are known to the skilled worker. Examples of suitable pigments are titanium dioxide, phthalocyanines, ultramarine blue, iron oxides, or carbon black, and also the entire class of organic pigments. In one embodiment, no pigments are used as additives D.

Examples of optional fillers may be selected from particulate fillers or reinforcing agents, are silicates, amorphous silica, calcium silicates, such as wollastonite, powdered quartz, mica, metal oxides, metal hydroxides, carbon black, graphite, barium sulfate, calcium carbonate, magnesium carbonate, bentonites, talc, kaolin, carbon fibers or glass fibers in the form of glass woven, glass mats, or glass silk rovings, chopped glass, or glass beads. In one embodiment, no fillers are used as additives D.

Examples of oxidation retarders and heat stabilizers are halides of the metals from group I of the periodic table, examples being sodium, potassium and/or lithium halides, optionally in combination with copper (I) halides, e.g., chlorides, bromides, iodides, sterically hindered phenols, hydroquinones, different substituted representatives of these groups, and mixtures thereof.

Examples of suitable stabilizers to counter the effect of light (e.g UV-stabilizers) are various substituted resorcinols, salicylates, benzotriazoles, benzophenones, and HALS (hindered amine light stabilizers), for example those commercially available as Tinuvin®.

### Polymer Composition P

The inventive polymer composition P at least comprises 0.1 to 50 parts by weight of at least one post-consumer recycled polymer as component A and 50 to 99.9 parts by weigh of at least one post-consumer recycled vinylaromatic copolymer as component B as defined herein above,
wherein the post-consumer recycled polymer A is dissolved in the vinylaromatic copolymer B and optionally vinylaromatic copolymer C, and/or
wherein the post-consumer recycled polymer A is dispersed in form of discontinuous phase domains in a continuous phase of the vinylaromatic copolymer B and optionally vinylaromatic copolymer C and wherein the discontinuous phase of the post-consumer recycled polymer A at least comprises phase domains having an average diameter in the range of >30 nm to ≤5 μm, preferably >30 nm to ≤2 μm, more preferably >30 nm to ≤200 nm, often >30 nm to ≤100 nm.

According to a preferred embodiment of the invention, the post-consumer recycled polymer A is dispersed in form of discontinuous phase domains in a continuous phase of the vinylaromatic copolymer B and optionally vinylaromatic copolymer C, and wherein the discontinuous phase of the post-consumer recycled polymer A comprises:
(i) phase domains having an average diameter in the range of from >30 nm to ≤5 μm, preferably >30 nm to ≤2 μm, more preferably >30 nm to ≤200 nm, often >30 nm to ≤100 nm, and
(ii) optionally phase domains having an average diameter in the range of from >0.1 to 30 nm.

In a preferred embodiment of the invention, the post-consumer recycled polymer A and the post-consumer recycled vinylaromatic polymer B are selected from different polymer classes. The vinylaromatic copolymer B and vinylaromatic copolymer C may be the same or different from each other, e.g. the vinylaromatic copolymer B and vinylaromatic copolymer C may be selected from the same polymer class or from different polymer classes. In one embodiment, the vinylaromatic copolymer B and the vinylaromatic copolymer C are selected from the same polymer class. In an alternative embodiment, the vinylaromatic copolymer B and the vinylaromatic copolymer C are selected from different polymer classes. Suitable polymer classes are defined herein above.

In one embodiment, the polymer composition P comprises at least two different polymer classes as the post-consumer recycled polymer A. In one preferred embodiment, the post-consumer recycled polymer A comprises at least two different polymer classes different from the post-consumer recycled vinylaromatic polymer B.

Preferred embodiments of the invention include polymer compositions P as described herein, comprising:
(a) at least one PMMA as component A and at least one SAN as component B;
(b) at least one PMMA as component A and at least one ABS as component B;
(c) at least one PMMA as component A and at least one ASA as component B;
(d) at least one TPU as component A and at least one SAN as component B;
(e) at least one TPU as component A and at least one ABS as component B;
(f) at least one TPU as component A and at least one ASA as component B;
(g) at least one AMSAN as component A and at least one SAN as component B;
(h) at least one AMSAN as component A and at least one ABS as component B;
(i) at least one AMSAN as component A and at least one ASA as component B;
(j) at least one PC as component A and at least one SAN as component B;
(k) at least one PC as component A and at least one ABS as component B;
(l) at least one PC as component A and at least one ASA as component B;
(m) at least one PA as component A and at least one SAN as component B;
(n) at least one PA as component A and at least one ABS as component B;
(o) at least one PA as component A and at least one ASA as component B;
or combinations of the aforementioned.

In one embodiment, the polymer compositions P comprise:
(a) at least one PMMA as component A and at least one SAN as component B;
(d) at least one TPU as component A and at least one SAN as component B;
(g) at least one AMSAN as component A and at least one SAN as component B;
(j) at least one PC as component A and at least one SAN as component B;
(m) at least one PA as component A and at least one SAN as component B;
or combinations of the aforementioned.

### Process for Recycling

The invention further relates to a process for the mechanical recycling of post-consumer recycled polymers A, wherein the process comprises the following process steps:
(i) providing at least one post-consumer recycled polymer A,
(ii) providing at least one (post-consumer recycled) vinylaromatic copolymer B,
(iii) optionally providing at least one non-post-consumer recycled vinylaromatic copolymer C,
(iv) optionally providing further additives D,
(v) melt-mixing 0.1 to 50 parts by weight, preferably 1 to 50 parts by weight of at least one post-consumer recycled polymer A, 50 to 99.9 parts by weight, preferably 50 to 99 parts by weight of the at least one post-consumer recycled vinylaromatic copolymer B and optionally 0 to 200 parts by weight of an essentially non-post-consumer recycled vinylaromatic copolymer C, optionally in the presence of 0 to 10 parts by weight of at least one further additive as component D,
(vi) extruding the melt-mixture obtained in process step (v),
wherein the post-consumer recycled polymer A comprises at least one polymer selected from the group consisting of polyolefins (such as polyethylene (PE), polypropylene (PP) and (ethylene/propylene) copolymers), polyamides (PA), polyesters such as polyethylene terephthalate (PET), polycarbonates (PC), thermoplastic polyurethanes (TPU), polyalkyl(meth)acrylates, such as polymethyl(meth)acrylate (PMMA), polyvinylchlorides (PVC), polystyrene (PS) and vinylaromatic copolymers such as vinylaromatic-diene copolymers (e.g. styrene-butadiene copolymers (SBC)), vinylaromatic-acrylonitrile copolymers (e.g. styrene-acrylonitrile copolymers (SAN) and alpha-methylstyrene-acrylonitrile copolymers (AMSAN)), vinylaromatic-diene-acrylonitrile copolymers (e.g. poly(acrylonitrile-butadiene-styrene) (ABS)) or vinylaromatic-acrylate copolymers (e.g. poly(acrylonitrile-styrene-acrylic ester) (ASA)).

Preferably, the process employs at least one post-consumer recycled vinylaromatic copolymer B and at least one post-consumer recycled polymer A which are different from each other. More preferably, the process employs at least two different post-consumer recycled polymers A. The post-consumer recycled polymer A preferably comprises at least one polymer selected from the group consisting of polycarbonates (PC), thermoplastic polyurethanes (TPU), polyalkyl(meth)acrylates, in particular polymethyl(meth)acrylate (PMMA), polyvinylchlorides (PVC), polystyrene (PS) and vinylaromatic copolymers such as vinylaromatic-diene copolymers (e.g. styrene-butadiene copolymers (SBC)), vinylaromatic-acrylonitrile copolymers (e.g. styrene-acrylonitrile copolymers (SAN) and alpha-methylstyrene-acrylonitrile copolymers (AMSAN)), vinylaromatic-diene-acrylonitrile copolymers (e.g. poly(acrylonitrile-butadiene-styrene) (ABS)) or vinylaromatic-acrylate copolymers (e.g. poly(acrylonitrile-styrene-acrylic ester) (ASA)).

The post-consumer recycled vinylaromatic copolymer B is preferably selected from the group consisting of styrene-acrylonitrile copolymers, blends of mixtures of at least one styrene-acrylonitrile copolymer with poly(acrylonitrile-butadiene-styrene) (ABS) or poly(acrylonitrile-styrene-acrylic ester) (ASA), and mixtures thereof.

A further aspect of the invention is a process for the preparation of a polymer composition P according to the invention by melt-mixing of components A, B and, if present, components C and/or D. Preferably the melt-mixing of the components A, B and, if present, components C and/or D is performed in an extruder, preferably a twin screw extruder.

The melt-mixing may be performed, preferably in an extruder, at temperatures in the range of from 160 to 260° C. Preferably, melt-mixing is performed in an extruder at temperatures in the range of from 180 to 230° C.

### Use and Applications

The invention also relates a method of using a post-consumer recycled vinylaromatic copolymer B for preparing a polymer composition P comprising at least one post-consumer recycled polymer A, wherein the post-consumer recycled polymer A is dissolved in the post-consumer recycled vinylaromatic copolymer B, or wherein the post-consumer recycled polymer A is dispersed in form of discontinuous phase domains in a continuous phase of the post-consumer recycled vinylaromatic copolymer B and wherein the discontinuous phase of the post-consumer recycled polymer A at least comprises phase domains having an average diameter in the range of >30 nm to ≤5 μm, preferably >30 nm to ≤2 μm, more preferably >30 nm to ≤200 nm, often >30 nm to ≤100 nm.

In a further aspect, the invention also relates to a process for the recycling of post-consumer polymers comprising at least one polymer A, wherein the post-consumer recycled polymer A is dissolved in the post-consumer recycled vinylaromatic copolymer B or wherein the post-consumer recycled polymer A is dispersed in form of discontinuous phase domains in a continuous phase of the post-consumer recycled vinylaromatic copolymer B and wherein the discontinuous phase of the post-consumer recycled polymer A at least comprises phase domains having an average diameter in the range of >30 nm to ≤5 μm, preferably >30 nm to ≤2 μm, more preferably >30 nm to ≤200 nm, often >30 nm to ≤100 nm.

Thus, in other words, the invention also relates to the use of a post-consumer recycled vinylaromatic copolymer B for preparing a polymer composition P comprising at least one post-consumer recycled polymer A, wherein the post-consumer recycled polymer A is dissolved in the post-consumer recycled vinylaromatic copolymer B or wherein the post-consumer recycled polymer A is dispersed in form of discontinuous phase domains in a continuous phase of the post-consumer recycled vinylaromatic copolymer B and wherein the discontinuous phase of the post-consumer recycled polymer A at least comprises phase domains having an average diameter in the range of >30 nm to ≤5 μm, preferably >30 nm to ≤2 μm, more preferably >30 nm to ≤200 nm, often >30 nm to ≤100 nm.

The invention also relates to the use of a post-consumer recycled vinylaromatic copolymer B for improving the compatibility of post-consumer recycled polymers A in a polymer composition P according to the invention, wherein the post-consumer recycled polymer A is dissolved in the post-consumer recycled vinylaromatic copolymer B or wherein the post-consumer recycled polymer A is dispersed in form of discontinuous phase domains in a continuous phase of the post-consumer recycled vinylaromatic copolymer B and wherein the discontinuous phase of the post-consumer recycled polymer A at least comprises phase domains having an average diameter in the range of >30 nm to ≤5 μm, preferably >30 nm to ≤2 μm, more preferably >30 nm to ≤200 nm, often >30 nm to ≤100 nm.

The constituents A, B, C, and D as well as the polymer composition P and the preferred embodiments thereof are as defined above.

The polymer composition P obtained by said process shows a good processability and thus can be easily processed, i.e. molded to any desired shape e.g. by extrusion and hot molding (e.g. injection molding).

Accordingly, a further aspect of the invention is a shaped article produced from the polymer composition P according to the invention.

The polymer composition P according to the invention can advantageously be used for many applications, including automotive parts such as mirrors, instrument panels, front grills, rear lights and light housings, door panels, center consoles, knobs and other instrument panel components, car interior upper and lower trims, seat components, spoilers, electroplated parts, fascia and mounting brackets; 2-wheeler parts such as side covers, indicators and indicator housings, lamps and lamp housings, tank embellishers, front fenders, seat cowls; computer/communication applications such as parts for cell phones, smart phones, tablet computers, stationary computers, GPS devices, landline telephones, telefax machines, antennae and communication systems; TV/monitor applications such as light diffuser plates (LDP), light guide panels (LGP), front, middle & rear covers, guide stand necks, stand bases; sports/leisure applications such as parts for game consoles, audio and video devices, E-book readers, walkie talkie systems, E-music instruments, E-bikes, sound systems; office equipment applications such as printer, copier & scanner housing parts, paper trays, feeders, separators and exterior parts, document backing, light pipes, transparent photo trays, printer drum units, printer platens, ink and toner cartridges; general electronic applications such as electrical installations, plugs and switches, battery housings, payment devices, house electronics (home safety and communication systems); kitchen applications such as parts for refrigerators, coolers, dishwashers, microwave ovens, cookers, exhaust fans (extraction units), coffee machines, toasters, mixers, blenders, filtered water containers; laundry room applications such as parts for washing machines, dryers, irons; personal hygiene applications such as parts for electric toothbrushes, electric razors/shavers, hair dryers, electroplated parts in sanitary applications like showerheads, knobs; general household applications such as parts for vacuum cleaners, carpet washers, air conditioners, air cleaners, humidifiers/de-humidifiers, water purifiers; building and construction applications such as decking/deck boards, fencing/railing, roofing/roof tiles, exterior siding/cladding, exterior trims, soffit linings, storm doors, door panels, window profiles, solar-panel support mounts, water drainage, sunroom walls, outdoor pool steps, decorative sheets, edge bands, exterior films, flooring, sanitary applications, shower trays, high-heat piping/ducts, window frame inner structures, solar panel housings, gutters, blending with PVC for improving heat resistance, impact strength and color retention; additional capstock applications over exterior PVC applications, parts for windmills/renewable energy production, insulation panels; medical/healthcare applications such as parts for IV systems and fluid delivery, IV tubing, lumen tubes, co-ex tubes, IV bags, IV drip chambers, spikes, connectors (rigid/flexible, Y, valves), stopcocks, rollerclamps, dialyzers, blood filters and reservoirs, diabetes devices and packaging, e.g. injection pens; labware such as titer plates, petri dishes, pipettes, sample spoons, cell growth bottles, cuvettes, centrifuge tubes, caps and closures, anesthesia-, blood analysis trays, diagnostic test kits, retinal surgery cassette, surgical instruments, handle grips, vaginal specular, electro surgical pencils, trocars, arthroscopes, endoscopes, microlaparoscopy instruments, anesthesia devices, endoscopy tube and parts, prosthesis; respiratory and drug delivery applications such as parts for inhalers, sleep apnea devices, insulin pens, insulin pumps, injection pens, needleless injection devices, syringes, nebulizers; mobile and digital health applications such as parts for medical monitoring, diagnostic systems, CT scanners, blood pressure monitors, thermometers, pulse oximeters; fitness devices, glucometers, AED, ultrasound instruments, wireless-, remote devices, medical trays, pouches, blisters, films, overwraps, film/multi layer film applications; packaging and other applications such as food packaging, technical packaging, containers, integrated circuit packaging, cosmetics packaging, household goods packaging, household sprayer and dispenser parts, foamed packaging and foamed trays, cosmetic jars, industrial batteries, water filter parts, food boxes, point-of-purchase displays, pens, toys, toy bricks and toy housings, toy figures, films.

A further object of the invention is the use of polymer composition P according to the invention and shaped articles produced therefrom for various applications as mentioned above.

The examples and the patent claims further illustrate the invention.

### EXAMPLES

In a mechanical recycling test, a series of polymers A-(i) to A-(viii) was blended with each other and with styrene (B-(i)) as well as with the vinylaromatic copolymers B-(ii) to B-(v):

| | |
|---|---|
| A-(i) | homo-polypropylene |
| A-(ii) | low density polyethylene |
| A-(iii) | polycarbonate (Makrolon 2800; Covestro) |
| A-(iv) | thermoplastic polyurethane (Elastollan; BASF) |
| A-(v) | polymethyl(meth)acrylate (Plexiglas 6N, Röhm) |
| A-(vi) | styrene-butadiene copolymer (Styrolux G55; INEOS Styrolution) |
| A-(vii) | polyethylene terephthalate (ground PET bottle grade) |
| A-(viii) | polyvinylchloride (Inovyn 264PC) |
| B-(i) | polystyrene (Polystyrene 158N, INEOS Styrolution) (reference |
| | example) |
| B-(ii) | styrene-acrylonitrile copolymer (S/AN 81/19) |
| B-(iii) | styrene-acrylonitrile copolymer (S/AN 75/25) |
| B-(iv) | styrene-acrylonitrile copolymer (S/AN 65/35) |
| B-(v) | styrene-acrylonitrile copolymer (S/AN 60/40) |

Extrusion compounding trials were run with blends having a 1:1 weight ratio (according to Table 1) under following conditions:
extruder: Coperion ZSK 30
temperature: 260° C.
number of revolutions [l/min]200-300
throughput 10 kg/h

Test of compatibility was done by investigating the micro- or macro-phase separation via optical microscopy on a 50 μm×50 μm photograph using following assessment scheme:
+ (good compatibility): polymer domain size on average 2 μm or below
0 (mediocre compatibility): polymer domain size on average 20 μm or below
− (poor/no compatibility): no visible miscibility/domain size>20 μm

The results are presented in Table 1.

TABLE 1
Mechanical recycling trials

| | A- | A- | A- | A- | A- | A- | A- | A- |
|---|---|---|---|---|---|---|---|---|
| | (i) | (ii) | (iii) | (iv) | (v) | (vi) | (vii) | (viii) |
| A-(i) | n/a | 0 | − | − | − | 0 | − | − |
| A-(ii) | 0 | n/a | − | − | − | 0 | − | − |
| A-(iii) | − | − | n/a | + | + | 0 | 0 | 0 |
| A-(iv) | − | − | + | n/a | 0 | − | 0 | 0 |
| A-(v) | − | − | + | 0 | n/a | 0 | 0 | 0 |
| A-(vi) | 0 | 0 | 0 | − | 0 | n/a | 0 | 0 |
| A-(vii) | − | − | 0 | 0 | 0 | 0 | n/a | 0 |
| A-(viii) | − | − | 0 | 0 | 0 | 0 | 0 | n/a |
| B-(i)* | − | − | + | + | − | + | − | − |
| B-(ii) | − | − | + | + | + | 0 | − | + |
| B-(iii) | − | − | + | + | + | 0 | − | + |
| B-(iv) | − | − | + | + | + | 0 | − | + |
| B-(v) | − | − | + | + | 0 | − | 0 | 0 |

*Reference example

As can be seen from the data presented in Table 1, polymer compositions P comprising vinylaromatic copolymers B-(ii) to B-(v) exhibit good or mediocre compatibility with various different polymers, such as polymers (A-iii) to (A-vi) and (A-viii), in particular (A-iii), (A-iv), (A-v) and (A-viii).

1-15. (canceled)

16. A polymer composition P comprising:
A: 0.1 to 50 parts by weight of at least one post-consumer recycled polymer A;
B: 50 to 99.9 parts by weight of at least one post-consumer recycled vinylaromatic copolymer B, comprising:
B1: 10 to 100 wt.-%, based on the total weight of the at least one post-consumer recycled vinylaromatic copolymer B, of at least one thermoplastic vinylaromatic copolymer B1, comprising:
B1.1: 1 to 81 wt.-%, based on the total weight of the at least one thermoplastic vinylaromatic copolymer B1, of repeating units of styrene;
B1.2: 19 to 35 wt.-%, based on the total weight of the at least one thermoplastic vinylaromatic copolymer B1, of repeating units of acrylonitrile;
B1.3: 0 to 80 wt.-%, based on the total weight of the at least one thermoplastic vinylaromatic copolymer B1, of repeating units of at least one monomer selected from the group consisting of methyl(meth)acrylate (MMA), maleic anhydride (MA), and N-phenyl-maleimide (n-PMI); and
B1.4: 0 to 20 wt.-%, based on the total weight of the at least one thermoplastic vinylaromatic copolymer B1, of repeating units of at least one further co-monomer different from B1.1, B1.2, and B1.3,
wherein B1.1, B1.2, B1.3, and B1.4 sum up to 100 wt.-% of the at least one thermoplastic vinylaromatic copolymer B1; and
B2: 0 to 90 wt.-%, based on the total weight of the at least one post-consumer recycled vinylaromatic copolymer B, of at least one impact-modifying polymer B2,
wherein B1 and B2 sum up to 100 wt.-% of the at least one post-consumer recycled vinylaromatic copolymer B;
C: 0 to 200 parts by weight of a non-post-consumer recycled (virgin) vinylaromatic copolymer C, comprising:
C1: 10 to 100 wt.-%, based on the total weight of the non-post-consumer recycled (virgin) vinylaromatic copolymer C, of at least one thermoplastic vinylaromatic copolymer C1, comprising:
C1.1: 1 to 81 wt.-%, based on the total weight of the at least one thermoplastic vinylaromatic copolymer C1, of repeating units of styrene and/or styrene derivatives;
C1.2: 19 to 35 wt.-%, based on the total weight of the at least one thermoplastic vinylaromatic copolymer C1, of repeating units of acrylonitrile and/or methacrylonitrile;
C1.3: 0 to 80 wt.-%, based on the total weight of the at least one thermoplastic vinylaromatic copolymer C1, of repeating units of at least one monomer selected from the group consisting of methyl(meth)acrylate (MMA), maleic anhydride (MA), and N-phenyl-maleimide (n-PMI); and
C1.4: 0 to 20 wt.-%, based on the total weight of the at least one thermoplastic vinylaromatic copolymer C1, of repeating units of at least one further co-monomer different from C1.1, C1.2, and C1.3,
wherein C1.1, C1.2, C1.3, and C1.4 sum up to 100 wt.-% of the at least one thermoplastic vinylaromatic copolymer C1; and
C2: 0 to 90 wt.-%, based on the total weight of the non-post-consumer recycled (virgin) vinylaromatic copolymer C, of at least one impact-modifying polymer C2,
wherein C1 and C2 sum up to 100 wt.-% of the non-post-consumer recycled (virgin) vinylaromatic copolymer C; and
D: 0 to 10 parts by weight of at least one further additive as component D,
wherein components A, B, C, and D sum up to 100 wt.-% of the polymer composition P,
wherein the at least one post-consumer recycled polymer A is dissolved in the at least one post-consumer recycled vinylaromatic copolymer B and optionally the non-post-consumer recycled (virgin) vinylaromatic copolymer C and/or wherein the at least one post-consumer recycled polymer A is dispersed in a form of discontinuous phase domains in a continuous phase of the at least one post-consumer recycled vinylaromatic copolymer B and optionally the non-post-consumer recycled (virgin) vinylaromatic copolymer C,
wherein the discontinuous phase of the at least one post-consumer recycled polymer A comprises phase domains having an average diameter in the range of >30 nm to ≤5 μm,
wherein the at least one post-consumer recycled polymer A and the at least one post-consumer recycled vinylaromatic polymer B are selected from different polymer classes,
wherein the at least one post-consumer recycled polymer A comprises at least one polymer selected from the group consisting of polyamides, polycarbonates, thermoplastic polyurethanes, polyalkyl(meth)acrylates, polyvinylchlorides, polystyrene, vinylaromatic-acrylonitrile copolymers, alphamethylstyrene-acrylonitrile copolymers, vinylaromatic-diene-acrylonitrile copolymers, and vinylaromatic-acrylate copolymers, and
wherein the at least one post-consumer recycled polymer A and the at least one post-consumer recycled vinylaromatic copolymer B are prepared from waste plastic material.

17. The polymer composition P of claim 16,
wherein the at least one post-consumer recycled polymer A is dispersed in the form of discontinuous phase domains in the continuous phase of the at least one post-consumer recycled vinylaromatic copolymer B and optionally the non-post-consumer recycled (virgin) vinylaromatic copolymer C, and
wherein the discontinuous phase of the at least one post-consumer recycled polymer A comprises:
(i) phase domains having an average diameter in the range of >30 nm to ≤5 μm; and
(ii) optionally phase domains having an average diameter in the range of >0.1 to ≤30 nm.

18. The polymer composition P of claim 16, wherein the at least one post-consumer recycled polymer A comprises at least one polymer selected from the group consisting of thermoplastic polyurethanes (TPU), polymethyl(meth)acrylates (PMMA), polyamide (PA), polycarbonates (PC), alphamethylstyrene-acrylonitrile copolymers (AMSAN), and polystyrenes (PS).

19. The polymer composition P of claim 16, wherein the at least one post-consumer recycled vinylaromatic copolymer B is selected from the group consisting of styrene-acrylonitrile copolymers, blends of mixtures of at least one styrene-acrylonitrile copolymers with poly(acrylonitrile-butadiene-styrene) (ABS) or poly(acrylonitrile-styrene-acrylic ester) (ASA), and mixtures thereof.

20. The polymer composition P of claim 16, wherein the polymer composition P comprises:
(a) at least one polymethyl(meth)acrylate (PMMA) as component A and at least one styrene-acrylonitrile (SAN) as component B;
(b) at least one PMMA as component A and at least one poly(acrylonitrile-butadiene-styrene) (ABS) as component B;
(c) at least one PMMA as component A and at least one poly(acrylonitrile-styrene-acrylic ester) (ASA) as component B;
(d) at least one thermoplastic polyurethane (TPU) as component A and at least one SAN as component B;
(e) at least one TPU as component A and at least one ABS as component B;
(f) at least one TPU as component A and at least one ASA as component B;
(g) at least one alpha-methylstyrene-acrylonitrile copolymer (AMSAN) as component A and at least one SAN as component B;
(h) at least one AMSAN as component A and at least one ABS as component B;
(i) at least one AMSAN as component A and at least one ASA as component B;
(j) at least one polystyrene (PC) as component A and at least one SAN as component B;
(k) at least one PC as component A and at least one ABS as component B;
(l) at least one PC as component A and at least one ASA as component B;
(m) at least one polyamide (PA) as component A and at least one SAN as component B;
(n) at least one PA as component A and at least one ABS as component B;
(o) at least one PA as component A and at least one ASA as component B; or
(p) combinations thereof.

21. A process for the mechanical recycling of post-consumer recycled polymers A, wherein the process comprises the following steps:
(i) providing at least one post-consumer recycled polymer A;
(ii) providing at least one post-consumer recycled vinylaromatic copolymer B;
(iii) optionally providing at least one non-post-consumer recycled vinylaromatic copolymer C;
(iv) optionally providing at least one further additive D;
(v) melt-mixing 0.1 to 50 parts by weight of the at least one post-consumer recycled polymer A, 50 to 99.9 parts by weight of the at least one post-consumer recycled vinylaromatic copolymer B, and optionally 0 to 200 parts by weight of the at least one non-post-consumer recycled vinylaromatic copolymer C, optionally in the presence of 0 to 10 parts by weight of the at least one further additive D; and
(vi) extruding the melt-mixture obtained in step (v),
wherein the at least one post-consumer recycled polymer A and the at least one post-consumer recycled vinylaromatic polymer B are selected from different polymer classes,
wherein the at least one post-consumer recycled polymer A comprises at least one polymer selected from the group consisting of polyamides, polycarbonates, thermoplastic polyurethanes, polyalkyl(meth)acrylates, polyvinylchlorides, polystyrene, vinylaromatic-acrylonitrile copolymers, alphamethylstyrene-acrylonitrile copolymers, vinylaromatic-diene-acrylonitrile copolymers, and vinylaromatic-acrylate copolymers,
wherein the at least one post-consumer recycled vinylaromatic copolymer B comprises:
B1: 10 to 100 wt.-%, based on the total weight of the at least one post-consumer recycled vinylaromatic copolymer B, of at least one thermoplastic vinylaromatic copolymer B1, comprising:
B1.1: 1 to 81 wt.-%, based on the total weight of the at least one thermoplastic vinylaromatic copolymer B1, of repeating units of styrene;
B1.2: 19 to 35 wt.-%, based on the total weight of the at least one thermoplastic vinylaromatic copolymer B1, of repeating units of acrylonitrile;
B1.3: 0 to 80 wt.-%, based on the total weight of the at least one thermoplastic vinylaromatic copolymer B1, of repeating units of at least one monomer selected from the group consisting of methyl(meth)acrylate (MMA), maleic anhydride (MA), and N-phenyl-maleimide (n-PMI); and
B1.4: 0 to 20 wt.-%, based on the total weight of the at least one thermoplastic vinylaromatic copolymer B1, of repeating units of at least one further co-monomer different from B1.1, B1.2, and B1.3,
wherein B1.1, B1.2, B1.3, and B1.4 sum up to 100 wt.-% of the at least one thermoplastic vinylaromatic copolymer B1; and
B2: 0 to 90 wt.-%, based on the total weight of the at least one post-consumer recycled vinylaromatic copolymer B, of at least one impact-modifying polymer B2,
wherein B1 and B2 sum up to 100 wt.-% of the at least one post-consumer recycled vinylaromatic copolymer B, and
wherein the at least one post-consumer recycled polymer A and the at least one post-consumer recycled vinylaromatic copolymer B are prepared from waste plastic material.

22. The process of claim 21, wherein the at least one post-consumer recycled vinylaromatic copolymer B is different from the at least one post-consumer recycled polymer A.

23. The process of claim 21, wherein the at least one post-consumer recycled polymer A comprises at least one polymer selected from the group consisting of thermoplastic polyurethanes (TPU), polymethyl(meth)acrylates (PMMA), polyamide (PA), polycarbonates (PC), alpha-methylstyrene-acrylonitrile copolymers (AMSAN), and polystyrenes (PS).

24. The process of claim 21, wherein the at least one post-consumer recycled vinylaromatic copolymer B is selected from the group consisting of styrene-acrylonitrile copolymers, blends of mixtures of at least one styrene-acrylonitrile copolymers with poly(acrylonitrile-butadiene-styrene) (ABS) or poly(acrylonitrile-styrene-acrylic ester) (ASA), and mixtures thereof.

25. A method for preparing a polymer composition P, the method comprising:
dissolving at least one post-consumer recycled polymer A in at least one post-consumer recycled vinylaromatic copolymer B or dispersing the at least one post-consumer recycled polymer A in a form of discontinuous phase domains in a continuous phase of the at least one post-consumer recycled vinylaromatic copolymer B, wherein the discontinuous phase of the at least one post-consumer recycled copolymer A comprises phase domains having an average diameter in the range of >30 nm to ≤5 μm,
wherein the at least one post-consumer recycled polymer A and the at least one vinylaromatic polymer B are selected from different polymer classes,
wherein the at least one post-consumer recycled polymer A comprises at least one polymer selected from the group consisting of polyamides, polycarbonates, thermoplastic polyurethanes, polyalkyl(meth)acrylates, polyvinylchlorides, polystyrene, vinylaromatic-acrylonitrile copolymers, alphamethylstyrene-acrylonitrile copolymers, vinylaromatic-diene-acrylonitrile copolymers, and vinylaromatic-acrylate copolymers,
wherein the at least one post-consumer recycled vinylaromatic copolymer B comprises:
B1: 10 to 100 wt.-%, based on the total weight of the at least one post-consumer recycled vinylaromatic copolymer B, of at least one thermoplastic vinylaromatic copolymer B1, comprising:
B1.1: 1 to 81 wt.-%, based on the total weight of the at least one thermoplastic vinylaromatic copolymer B1, of repeating units of styrene;
B1.2: 19 to 35 wt.-%, based on the total weight of the at least one thermoplastic vinylaromatic copolymer B1, of repeating units of acrylonitrile;
B1.3: 0 to 80 wt.-%, based on the total weight of the at least one thermoplastic vinylaromatic copolymer B1, of repeating units of at least one monomer selected from the group consisting of methyl(meth)acrylate (MMA), maleic anhydride (MA), and N-phenyl-maleimide (n-PMI); and
B1.4: 0 to 20 wt.-%, based on the total weight of the at least one thermoplastic vinylaromatic copolymer B1, of repeating units of at least one further co-monomer different from B1.1, B1.2, and B1.3,
wherein B1.1, B1.2, B1.3, and B1.4 sum up to 100 wt.-% of the thermoplastic vinylaromatic copolymer B1; and
B2: 0 to 90 wt.-%, based on the total weight of the at least one post-consumer recycled vinylaromatic copolymer B, of at least one impact-modifying polymer B2,
wherein B1 and B2 sum up to 100 wt.-% of the at least one post-consumer recycled vinylaromatic copolymer B, and
wherein the at least one post-consumer recycled polymer A and the at least one post-consumer recycled vinylaromatic copolymer B are prepared from waste plastic material.

26. The method of claim 25, wherein the polymer composition P comprises:
(a) at least one polymethyl(meth)acrylate (PMMA) as component A and at least one styrene-acrylonitrile (SAN) as component B;
(b) at least one PMMA as component A and at least one poly(acrylonitrile-butadiene-styrene) (ABS) as component B;
(c) at least one PMMA as component A and at least one poly(acrylonitrile-styrene-acrylic ester) (ASA) as component B;
(d) at least one thermoplastic polyurethane (TPU) as component A and at least one SAN as component B;
(e) at least one TPU as component A and at least one ABS as component B;
(f) at least one TPU as component A and at least one ASA as component B;
(g) at least one alpha-methylstyrene-acrylonitrile copolymer (AMSAN) as component A and at least one SAN as component B;
(h) at least one AMSAN as component A and at least one ABS as component B;
(i) at least one AMSAN as component A and at least one ASA as component B;
(j) at least one polystyrene (PC) as component A and at least one SAN as component B;
(k) at least one PC as component A and at least one ABS as component B;
(l) at least one PC as component A and at least one ASA as component B;
(m) at least one polyamide (PA) as component A and at least one SAN as component B;
(n) at least one PA as component A and at least one ABS as component B;
(o) at least one PA as component A and at least one ASA as component B; or
(p) combinations thereof.

27. The polymer composition P of claim 16, wherein the discontinuous phase of the at least one post-consumer recycled copolymer A comprises phase domains having an average diameter in the range of >30 nm to ≤2 μm.

28. The polymer composition P of claim 16, wherein the discontinuous phase of the at least one post-consumer recycled copolymer A comprises phase domains having an average diameter in the range of >30 nm to ≤200 nm.

29. The polymer composition P of claim 16, wherein the discontinuous phase of the at least one post-consumer recycled copolymer A comprises phase domains having an average diameter in the range of >30 nm to ≤100 nm.

30. The method of claim 25, wherein the discontinuous phase of the at least one post-consumer recycled copolymer A comprises phase domains having an average diameter in the range of >30 nm to ≤2 μm.

31. The method of claim 25, wherein the discontinuous phase of the at least one post-consumer recycled copolymer A comprises phase domains having an average diameter in the range of >30 nm to ≤200 nm.

32. The method of claim 25, wherein the discontinuous phase of the at least one post-consumer recycled copolymer A comprises phase domains having an average diameter in the range of >30 nm to ≤100 nm.
